(19) United States
(12) Patent Application Publication
(10) Pub. No.: US 2012/0043371 A1
(43) Pub. Date: Feb. 23, 2012

(54) WIRING SUBSTRATE MANUFACTURING METHOD

(75) Inventors: Takahiro HAYASHI, Komaki-shi (JP); Satoru WATANABE, Minokamo-shi (JP); Hajime SAIKI, Konan-shi (JP); Koji SAKUMA, Komaki-shi (JP)

(73) Assignee: NGK SPARK PLUG CO., LTD., Nagoya-shi (JP)

(21) Appl. No.: 13/215,661

(22) Filed: Aug. 23, 2011

(30) Foreign Application Priority Data
Aug. 23, 2010 (JP) 2010-186687

(51) Int. Cl. B23K 1/20

(52) U.S. Cl. 228/208

(57) ABSTRACT

A wiring substrate includes a conductor layer and a resin insulating layer stacked alternately, solder resist layers formed on outermost surfaces on a first principal surface side and an opposing second principal surface side respectively, and outermost conductor layers exposed from opening portions formed in the respective solder resist layers. A method of manufacturing the wiring substrate includes: forming a first underlying layer and a second underlying layer on the respective outermost conductor layers; supplying a first solder onto the first underlying layer, and a second solder onto the second underlying layer; and connecting the first solder to the first underlying layer and the second solder to the second underlying layer respectively, by heating the first solder and the second solder simultaneously.

### CROSS-REFERENCE TO RELATED APPLICATIONS

The present application claims priority from Japanese Patent Application No. 2010-186687, which was filed on Aug. 23, 2010, the disclosure of which is herein incorporated by reference in its entirety.

### BACKGROUND OF THE INVENTION

1. Technical Field

The present invention relates to a wiring substrate manufacturing method.

2. Description of the Related Art

In recent years, manufacturers have eagerly produced a semiconductor package utilizing a wiring substrate (also referred to herein as a “wiring substrate assembly”) in which a conductor layer and a resin insulating layer are laminated alternately in at least one layer (combining the alternately laminated conductor layer and resin insulating layer) respectively on at least one principal surface of a core layer, and then a solder resist layer is formed on the outermost surface thereof, i.e., a so-called resin-made wiring substrate. Then, a semiconductor device is mounted thereon.

The semiconductor device is connected electrically to the wiring substrate via respective solder bumps that are formed on metal pads in a semiconductor device mounting portion on a principal surface of the wiring substrate. In contrast, external terminals connected electrically to a base substrate or inserted in sockets and connected electrically thereto are formed on a back surface side of the wiring substrate. Here, according to a package mode of the external terminals, the wiring substrates are classified into a ball grid array (BGA), a pin grid array (PGA), etc.

A wiring substrate of the PGA type can be obtained as follows. That is, a solder paste is printed on respective metal pads formed on the principal surface of a wiring substrate assembly. The solder paste is then subjected to a reflow soldering process in heating equipment to form solder bumps. Then, pins are inserted into respective opening portions that are formed in a solder resist layer on a back surface of the wiring substrate assembly, and then the pins are connected electrically to portions of the conductor layer exposed from respective opening portions.

A wiring substrate of the BGA type can be obtained as follows. That is, a solder paste is printed on respective metal pads formed on the principal surface of a wiring substrate assembly. The solder paste is then subjected to a reflow soldering process in heating equipment to form solder bumps. Then, solder balls are mounted on portions of the conductor layer that are exposed from respective opening portions formed in a solder resist layer on a back surface of the wiring substrate assembly, and then the solder balls are connected electrically and mechanically to the portions of the conductor layer, respectively, by applying the reflow soldering process in heating equipment.

However, in the case of the wiring substrate of the BGA type, when the solder balls are mounted directly on the portions of the conductor layer, adhesion of the solder balls to the portions of the conductor layer cannot be improved by the reflow soldering process, and thus the solder balls individually get out of (i.e., are dislodged from) their original mounting positions. For example, in some cases the electrical and mechanical connection between the wiring substrate and the base substrate cannot be sufficiently maintained. In both the PGA type and the BGA type, such a problem arose that, when the solder bumps are formed directly on the respective metal pads formed on the principal surface of the wiring substrate respectively, adhesion between the solder bumps and the respective metal pads cannot be sufficiently ensured and, thus, the electrical and mechanical connection cannot be sufficiently ensured.

In order to deal with such problem, a method has been proposed in which a predetermined solder paste is printed on the metal pads or the portions of the conductor layer that are exposed from opening portions formed in the solder resist layer on the wiring substrate assembly. Then, portions of respective underlying layers located under the solder bumps and the solder balls are formed by ref lowing the solder paste, and then the solder bumps or the solder balls are formed (or mounted) on the portions of the underlying layers and connected to them respectively by applying a reflow soldering process (see: JP-A-2006-173143 Official Gazette).

In the meanwhile, even when the respective portions of the underlying layers are formed in this manner, the solder bumps or the solder balls are formed sequentially on the principal surface side and the back surface side of the wiring substrate assembly. For example, the solder paste is printed on the respective portions of the underlying layer on the principal surface side of the wiring substrate assembly and then the reflow soldering process is applied to the solder paste in the heating equipment such that the solder bumps are formed. Then, the solder ballsare mounted on the respective portions of the underlying layer on the back surface side of the wiring substrate assembly, and then the solder balls are connected (i.e., melted) to the respective portions of the underlying layer on the back surface side by applying the reflow soldering process in the heating equipment.

However, as described above, when the solder bumps and the solder balls are formed on the principal surface side and the back surface side of the wiring substrate assembly separately, the portions of the underlying layer formed on the back surface side of the wiring substrate assembly, for example, are subjected to the heating process twice in the heating equipment when the solder bumps are to be formed on the principal surface side of the wiring substrate assembly and when the solder balls are to be formed on the back surface side of the wiring substrate assembly. In other words, the portions of the underlying layer formed on the back surface side of the wiring substrate assembly are put under the heating process for a long time, in comparison with the portions of the underlying layer formed on the principal surface side of the wiring substrate assembly. As a result, a problem arises in that when an oxide film is formed on the surfaces of the portions of the underlying layer and then the portions of the underlying layer are fused by the reflow soldering process, wettability of the portions of the underlying layer with respect to the conductor layer located under the underlying layer is lowered and, thus, degradation of the connectivity of the portions of the underlying layer with respect to the solder balls to be formed subsequently is caused.

The solder bumps formed on the principal surface side of the wiring substrate assembly are subjected to the heating process twice in the heating equipment: once when the concerned solder bumps are formed and once when the solder balls are formed on the back surface side of the wiring substrate assembly. Therefore, an intermetallic compound acting to lower a connection strength between them is formed on the boundaries between the underlying layers and the solder bumps respectively. As a result, a problem arises in that degradation of the connectivity of the solder bumps is caused.

### BRIEF SUMMARY OF THE INVENTION

It is an object of the present invention to provide a new wiring substrate manufacturing method capable of improving adhesion between a conductor layer and solder bumps, etc. in a wiring substrate in which a conductor layer and a resin insulating layer are stacked alternately, a solder resist layer is formed on outermost surfaces on a first principal surface side and a second principal surface side opposing to the first principal surface respectively, and the conductor layer is exposed from opening portions formed in the solder resist layers respectively.

In order to attain the above object, the present invention is concerned with a method of manufacturing a wiring substrate having a first principal surface side and a second principal surface side opposing to the first principal surface side, the wiring substrate including conductor layers and resin insulating layers alternately stacked, and solder resist layers having opening portions and formed on an outermost surface of each of the first principal surface side and the second principal surface side, respectively, such that outermost conductor layers of the conductor layers are exposed from the opening portions of the respective solder resist layers, and includes

an underlying layer forming step of forming Sn-containing underlying layers on the respective outermost conductor layers exposed from the opening portions, the Sn-containing underlying layers including a first underlying layer positioned on the first principal surface side and a second underlying layer positioned on the second principal surface side;

a solder supplying step of supplying a first solder onto the first underlying layer and a second solder onto the second underlying layer; and

a solder connecting step of connecting the first solder to the first underlying layer and the second solder to the second underlying layer, by heating the first solder and the second solder simultaneously.

According to the present invention, the Sn-containing underlying layer is formed on the conductor layer exposed from the opening portion formed in the solder resist layer on the first principal surface side, particularly the portions of the conductor layer exposed from the opening portion, and the conductor layer exposed from the opening portion formed in the solder resist layer on the second principal surface side, particularly the portions of the conductor layer exposed from the opening portion, in the wiring substrate in which the conductor layers and the resin insulating layers are stacked alternately, the solder resist layers are formed on the outermost surfaces on the first principal surface side and the second principal surface side opposing to the first principal surface respectively, and the conductor layers are exposed from the opening portions formed in the respective solder resist layers.

The underlying layers can be formed simply by the plating method, for example. Therefore, their shapes are flat and the underlying layers contain Sn as a main component of solder. Accordingly, when the underlying layers are fused by the heating and then the first solder and the second solder such as the solder bumps, the solder balls, and the like are formed thereon, these solders can be connected firmly to the underlying layers.

In the present invention, the first solder and the second solder such as the solder bumps, the solder balls, and the like are supplied to the underlying layers, and then these solders are heated simultaneously to apply the reflow soldering process. Therefore, such a situation can be avoided that only the underlying layers formed on one of the principal surface and the back surface of the wiring substrate are put under the heating process for a long time, unlike the prior art. As a result, such a situation is never caused that the oxide film is formed only on the surfaces of one underlying layers, wettability of these underlying layers is lowered, and thus connectivity to the first solder or the second solder to be formed later is degraded.

Further, in the present invention, such a situation can be avoided that only one of the first solder and the second solder such as the solder bumps, the solder balls, and the like are put under the heating process for a long time. Accordingly, it can be suppressed that an intermetallic compound acting to lower the connection strength between them is formed on the boundaries between the underlying layers and the first solder and the second solder. As a result, the connectivity between the underlying layers and the first solder and the second solder is not degraded.

With the above, according to the present invention, the adhesion between the first conductor layer and the second conductor layer exposed from the first opening portions and the second opening portions respectively and the first solder and the second solder such as the solder bumps, etc. can be improved, in the wiring substrate in which the conductor layer and the resin insulating layer are stacked alternately, the solder resist layer is formed on the outermost surfaces on the first principal surface side and the second principal surface side opposing to the first principal surface respectively, and the conductor layer is exposed from the opening portions formed in the solder resist layers respectively.

Here, in an example of the present invention, at least one of the first solder and the second solder is a solder paste that contains a flux for oxide film removal, i.e., is formed as the solder bump that is obtained via the later reflow soldering process.

In an example of the present invention, at least one of the first solder and the second solder is a solder paste, and the method further includes a flux supplying step of supplying a flux for oxide film removal to the underlying layers to which the solder paste is supplied respectively, after the underlying layer forming step but before the solder supplying step. In this case, even when the solder paste does not contain the flux for oxide film removal, the oxide film that is formed on the surfaces of the underlying layers upon heating later the first solder and the second solder can be removed by supplying the flux for oxide film removal to either of the first underlying layer and the second underlying layer, to which the solder paste is supplied, after the underlying layer formation but before the solder supply.

Both the first solder and the second solder may be formed as the solder paste. Further, the flux for oxide film removal may be supplied to both the first underlying layerand the second underlying layer, and then the solder paste may be supplied onto either of the first underlying layerand the second underlying layer, to which the flux is supplied.

Here, the above flux for oxide film removal can activate the solder paste in the heating process, and also can remove the oxide contained in the solder paste.

Further, in an example of the present invention, at least one of the first solder and the second solder is the solder ball, and the method further includes a flux supplying step of supplying a flux for oxide film removal to the underlying layers to which the solder ball is supplied respectively, after the underlying layer forming step but before the solder supplying step. In this case, even when the solder ball does not contain the flux for oxide film removal, the flux for oxide film removal can be supplied to either of the first underlying layer and the second underlying layer, to which the solder paste is supplied, after the underlying layer formation but before the solder supply, so as to remove the oxide film that is formed on the surfaces of the underlying layers on which the solder ball is to be formed respectively, and as a result the oxide film that is formed on the surfaces of the underlying layers can be removed.

Both the first solder and the second solder may be formed as the solder ball. Since the flux is supplied before the solder ball is supplied to the underlying layers, the solder ball is held by a surface tension of the flux at the moment when the solder ball is supplied. Therefore, the solder ball supplied to one of the principal surface sides is never dropped by its own weight in the course of the carry in the solder connecting step, or the like, and occurrence of the connection failure can be prevented.

As described above, according to the present invention, the new wiring substrate manufacturing method improves adhesion between the conductor layer and the solder bumps, and the like, in the wiring substrate in which the conductor layer and the resin insulating layer are stacked alternately, the solder resist layers are formed on the outermost surfaces on the first principal surface side and the second principal surface side opposing to the first principal surface respectively, and the conductor layers are exposed from the opening portions formed in the respective solder resist layers.

### BRIEF DESCRIPTION OF THE DRAWINGS

Illustrative aspects of the invention will be described in detail with reference to the following figures wherein:

FIG. 1 is a plan view showing a wiring substrate in an embodiment;

FIG. 2 is a plan view also showing the wiring substrate in the embodiment;

FIG. 3 is a view showing a part of a section in an enlarged fashion when the wiring substrates shown in FIGS. 1 and 2 are cut along a I-I line;

FIG. 4 is a view showing a part of a section in an enlarged fashion when the wiring substrates shown in FIGS. 1 and 2 are cut along a II-II line;

FIG. 5 is a view showing one process in a wiring substrate manufacturing method in the embodiment;

FIG. 6 is a view showing one process in the wiring substrate manufacturing method in the embodiment;

FIG. 7 is a view showing one process in the wiring substrate manufacturing method in the embodiment;

FIG. 8 is a view showing one process in the wiring substrate manufacturing method in the embodiment;

FIG. 9 is a view showing one process in the wiring substrate manufacturing method in the embodiment;

FIG. 10 is a view showing one process in the wiring substrate manufacturing method in the embodiment;

FIG. 11 is a view showing one process in the wiring substrate manufacturing method in the embodiment;

FIG. 12 is a view showing one process in the wiring substrate manufacturing method in the embodiment;

FIG. 13 is a view showing one process in the wiring substrate manufacturing method in the embodiment;

FIG. 14 is a view showing one process in the wiring substrate manufacturing method in the embodiment; and

FIG. 15 is a view showing one process in the wiring substrate manufacturing method in the embodiment.

### DETAILED DESCRIPTION OF EXEMPLARY EMBODIMENTS OF THE INVENTION

An embodiment of the present invention will be explained with reference to the drawings hereinafter.

Exemplary Wiring Substrate

First, a configuration of an exemplary wiring substrate that is to be manufactured by the method of the present invention will be explained hereunder. Here, the wiring substrate shown hereunder is given only by way of illustration. The wiring substrate includes at least a first conductor layer and a first resin insulating layer are stacked on a first principal surface of a core layer, a first solder resist layer is formed on an outermost surface, at least the first conductor layer is exposed from first opening portions formed in this first solder resist layer, at least a second conductor layer and a second resin insulating layer are stacked on a second principal surface of the core layer opposing to the first principal surface, a second solder resist layer is formed on an outermost surface, and an Sn-containing underlying layer and solder are formed on the exposed first conductor layer and the exposed second conductor layer respectively based on the features of the manufacturing method of the present invention.

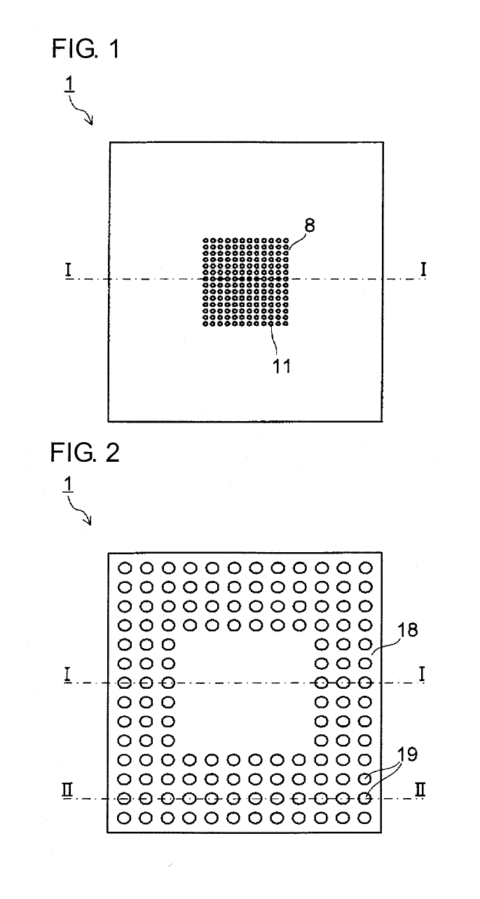

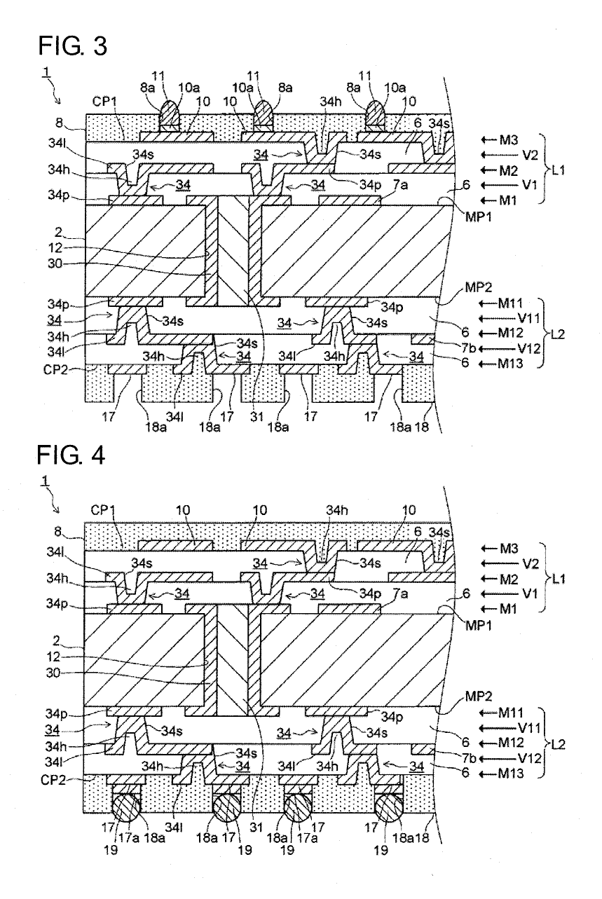

FIG. 1 and FIG. 2 are respective plan views of a wiring substrate according to the present embodiment. FIG. 1 shows a state of a wiring substrate when viewed from the upper side, and FIG. 2 shows a state of the wiring substrate shown in FIG. 1 when viewed from the lower side. FIG. 3 is a view showing a part of a section in an enlarged fashion when the wiring substrate shown in FIGS. 1 and 2 is cut along line I-I. FIG. 4 is a view showing a part of a section in an enlarged fashion when the wiring substrate shown in FIGS. 1 and 2 is cut along line II-II.

In a wiring substrate 1 shown in FIGS. 1 to 4, core conductor layers M1, M11 (also referred simply to as a “conductor layer” respectively hereinafter) each of which is shaped into a predetermined pattern to constitute a metal wiring 7a are formed on both surfaces of a plate-like core 2 by the Cu plating respectively. This plate-like core 2 is constructed by a heat-resistant resin plate (e.g., a bismuleimide-triazine resin plate), a fiber reinforced resin plate (e.g., a glass-fiber reinforced epoxy resin), or the like. These core conductor layers M1, M11 are formed as a surface conductor pattern that covers most of a surface of the plate-like core 2 respectively, and are used as a power supply layer or a ground layer.

Meanwhile, through holes 12 that are bored with a drill, or the like are formed in the plate-like core 2, and a through hole conductor 30 that causes the core conductor layers M1, M11 to conduct mutually is formed on their inner wall surfaces respectively. The through holes 12 are filled by a resin hole-filling material 31 such as an epoxy resin, or the like.

First via layers (build-up layers: insulating layers) V1, V11 each formed of a thermosetting resin composite 6 are formed on upper layers of the core conductor layers M1, M11 respectively. First conductor layers M2, M12 each of which is shaped into a predetermined pattern to constitute a metal wiring 7b are formed on their surfaces by the Cu plating respectively. Here, an interlayer connection is provided between the core conductor layers M1, M11 and the first conductor layers M2, M12 by vias 34 respectively. Similarly, second via layers (build-up layers: insulating layers) V2, V12 each formed of the thermosetting resin composite 6 are formed on upper layers of the first conductors layers M2, M12 respectively.

Second conductor layers M3, M13 having metal terminal pads 10, 17 respectively are formed on the second via layers V2, V12 respectively. An interlayer connection is provided between the first conductor layers M2, M12 and the second conductor layers M3, M13 by the vias 34 respectively. The vias 34 include via holes 34h, via conductors 34s each provided on an inner peripheral surface of the via hole 34h, via pads 34p each provided to be connected to the via conductor 34s at its bottom surface side, and via lands 34l each protruded outward from an opening periphery of the via hole 34h on the opposite side to the via pad 34p.

As described above, the core conductor layer M1, the first via layer V1, the first conductor layer M2, the second via layer V2, and the second conductor layer M3 are stacked sequentially on a first principal surface MP1 of the plate-like core 2 to constitute a first wiring stacking portion L1. The core conductor layer M11, the first via layer V11, the first conductor layer M12, the second via layer V12, and the second conductor layer M13 are stacked sequentially on a second principal surface MP2 of the plate-like core 2 to constitute a second wiring stacking portion L2. Then, a plurality of metal terminal pads 10 are formed on a first main surface CP1, and a plurality of metal terminal pads 17 are formed on a second main surface CP2.

Here, the metal terminal pads 10 are used as the pads (FC pads) to which a semiconductor device (not shown) is flip-chip connected via solder bumps formed later, and constitute a semiconductor device mounting area respectively. As shown in FIG. 1, the metal terminal pads 10 are formed in an almost center portion of the wiring substrate 1, and are aligned like a rectangular shape.

The metal terminal pads 17 are utilized as back surface lands (LGA pads) used to connect the wiring substrate 1 to a mother board. The metal terminal pads 17 are formed in the outer peripheral area of the wiring substrate 1 except the substantially center area, and are aligned like a rectangular shape to surround the substantially center area.

Further, a solder resist layer 8 having opening portions 8a is formed on the first main surface CP1. A Sn-containing underlying layer 10a formed by the plating method such as the electroless Sn plating, the electrolytic Sn plating, or the like is formed on the metal terminal pads 10, each exposed from the opening portion 8a, respectively. Solder bumps 11 obtained by printing a first solder, i.e., a solder paste, and then applying the reflow (i.e., reflow soldering process) are formed on the underlying layer 10a.

Here, either the paste containing oxide film removing fluxes or the paste containing no flux may be employed as the solder paste. In the later case, as explained hereunder, it is preferable that, in order to remove the oxide film formed on the surface of the underlying layer 10a, the oxide film formed on the surface should be removed by processing the underlying layer 10a separately by using the oxide film removing fluxes.

A solder resist layer 18 having opening portions 18a is formed on the second main surface CP2. The underlying layer 17a containing Sn is formed on the metal terminal pads 17, which are exposed from the opening portions 18a, respectively. A solder ball 19 serving as a second solder is formed on the underlying layers 17a respectively such that this solder ball is connected to the underlying layers 17a. Here, commonly the solder balls 19 contain no oxide film removing flux. Therefore, as explained hereunder, it is preferable that, in order to remove the oxide film formed on the surface of the underlying layer 17a, the oxide film formed on the surface should be removed by processing the underlying layer 17a separately by using the oxide film removing fluxes.

Here, the solder bumps 11 and the solder balls 19 can be formed of Sn—Pb, Sn—Ag, Sn—Ag—Cu, or the like, for example.

In the wiring substrate 1 of the embodiment, the Sn-containing underlying layers 10a, 17a are formed on the metal terminal pads 10, 17, which are exposed from the opening portion 8a, 18a respectively, correspondingly. The underlying layers 10a, 17a can be formed simply by the plating method such as the electrolytic Sn plating, the electroless Sn plating, or the like. Therefore, their shapes are flat and they contain Sn as a main component of solder. Accordingly, in the wiring substrate 1 of the present embodiment, when the underlying layers 10a, 17a are fused by the heating and then the solder bumps 11 and the solder balls 19 are formed thereon respectively, the solder balls 19 can be connected firmly to the underlying layers 17a respectively.

Here, in the present embodiment, the reflow soldering process applied to form the solder bumps 11 and the solder balls 19 by the heating are executed simultaneously. In this case, either the underlying layers 10a formed on the first main surface CP1 of the wiring substrate 1 or the underlying layers 17a formed on the second main surface CP2 of the wiring substrate 1 are never put under the similar heating process while the remaining underlying layers 17a or 10a are subjected to the reflow soldering process by the heating. For example, when it is tried to at first form the solder bumps 11 by the reflow soldering process and then form the solder balls 19 by the reflow soldering process, the underlying layers 17a located under the solder balls 19 respectively are subjected to the heating process twice in the heating equipment both when the reflow soldering process is applied to the solder bumps 11 and when the reflow soldering process is applied to the solder balls 19.

In other words, the underlying layers 17a located under the solder balls 19 are put under the heating process for a long time, in comparison with the underlying layers 10a located under the solder bump 11. As a result, such a problem arises that, when the oxide film is formed on the surfaces of the underlying layers 17a and the underlying layers are fused by the reflow soldering process, wettability of the underlying layers with respect to the metal terminal pads 17 located under the underlying layers is lowered and thus degradation of connectivity of the underlying layers with respect to the solder balls 19 to be formed later is caused.

However, as described above, since the reflow soldering process applied to form the solder bumps 11 and the solder balls 19 by the heating are executed simultaneously, such a situation can be prevented that either of the underlying layers 10a and 17a located under the solder bumps 11 and the solder balls 19 are put under the heating process for a long time. Accordingly, the above-mentioned disadvantage caused due to the fact that either of the underlying layers 10a and 17a are put under the heating process for a long time can be eliminated.

As described above, in the present embodiment, since the reflow soldering process applied to form the solder bumps 11 and the solder balls 19 by the heating is executed simultaneously, either the solder bumps 11 or the solder balls 19 are never put under the similar heating process while the remaining solder balls 19 or solder bumps 11 are subjected to the reflow soldering process by the heating. For example, when it is tried to at first form the solder bumps 11 by the reflow soldering process and then form the solder balls 19 by the reflow soldering process, the solder bumps 11 are subjected to the heating process twice in the heating equipment both when the solder bumps 11 are formed and when the solder balls 19 are formed.

That is, the solder bumps 11 are put under the heating process for a long time in contrast to the solder balls 19. In this case, an intermetallic compound acting to lower connection strength between them is formed on the boundaries between the underlying layers 10a and the solder bumps 11 respectively. As a result, such a problem arises that degradation of connectivity of the solder bumps 11 is caused.

However, as described above, since the reflow soldering process applied to form the solder bumps 11 and the solder balls 19 by the heating are executed simultaneously, such a situation can be prevented that either of the solder bumps 11 and the solder balls 19 are put under the heating process for a long time. Accordingly, the above-mentioned disadvantage caused due to the fact that either of form the solder bumps 11 and the solder balls 19 are put under the heating process for a long time can be eliminated.

Here, in the present embodiment, as shown in FIG. 4, the solder balls 19 are used as the solder that is formed on the second main surface CP2 of the wiring substrate 1. In this case, as occasion demands, the solder bumps formed on the first main surface CP1 may be employed. The solder bumps 11 are used as the solder that is formed on the first main surface CP1 of the wiring substrate 1. In this case, as occasion demands, the solder balls formed on the second main surface CP2 may be employed.

As apparent from FIGS. 1 to 4, the wiring substrate 1 of the present embodiment shows a substantially rectangular plane-like shape. A size of the wiring substrate 1 can be set to about 35 mm×about 35 mm×about 1 mm, for example.

Exemplary Wiring Substrate Manufacturing Method

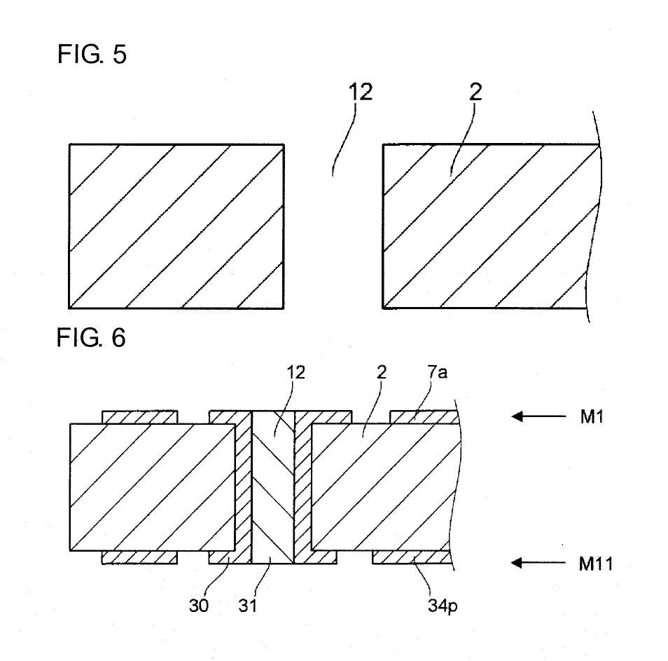

Next, an exemplary wiring substrate manufacturing method of the exemplary wiring substrate shown in FIGS. 1 to 4 will be explained hereunder. FIGS. 5 to 15 are views showing processes in the wiring substrate manufacturing method in the present embodiment. Here, process views shown hereunder illustrate mainly the sequential processes applied to the corresponding sections in FIG. 4 respectively when the wiring substrate is cut along line II-II.

At first, as shown in FIG. 5, a heat-resistant resin plate (e.g., a bismuleimide-triazine resin plate) or a fiber reinforced resin plate (e.g., a glass-fiber reinforced epoxy resin), which is shaped into a plate, is prepared as the core 2, and the through holes 12 are bored by the method such as the drilling, or the like. Then, as shown in FIG. 6, the core conductor layers M1, M11 and the through hole conductors 30 are formed by the pattern plating, and the resin hole-filling material 31 is filled in the through holes 12 respectively.

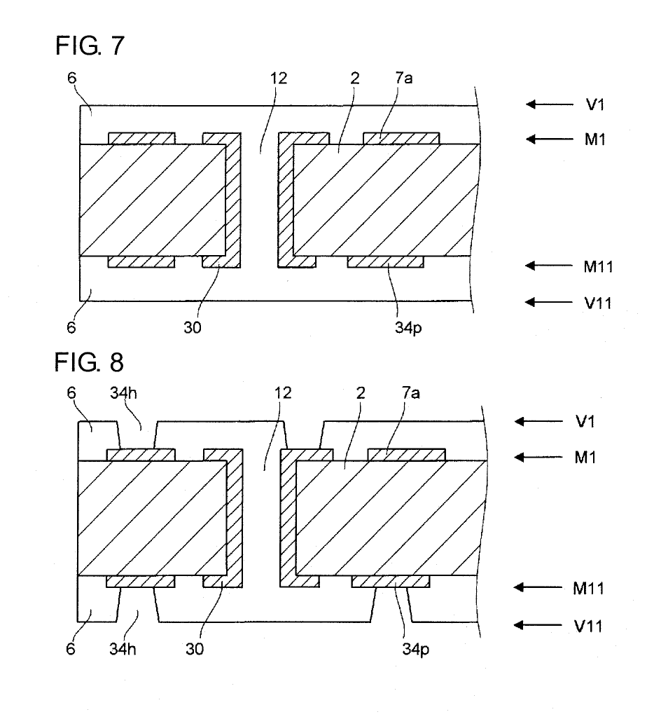

Then, the roughening process is applied to the core conductor layers M1, M11. Then, as shown in FIG. 7, the insulating layers V1, V11 are obtained by laminating the resin film 6 to cover the core conductor layers M1, M11, and then curing the film. As occasion demands, the resin film may contain the fillers.

Then, as shown in FIG. 8, the via holes 34h are formed into a predetermined pattern respectively by irradiating the laser beam onto the principal surface of the insulating layers V1, V11 (via layers). Then, the roughening process is applied to the insulating layers V1, V11 containing the via holes 34h. Here, when the roughening process is applied to the insulating layers V1, V11, as described above, in such a situation that the insulating layers V1, V11 contain the fillers, the liberation of the fillers is caused and the fillers still remain on the insulating layers V1, V11. Therefore, the liberated fillers are removed by applying appropriately the water rinsing.

Then, the desmear process and the outline etching are applied to rinse the inside of the via holes 34h. Here, in the present embodiment, flocculation of the fillers caused in the course of the water rinsing in the desmear process can be suppressed since the water rinsing is already applied.

In the present embodiment, the air blowing may be applied between the above water rinsing using a high water pressure and the desmear process. Accordingly, even though the liberated fillers are not completely removed by the above water rinsing, removal of the fillers can be complemented by the air blowing.

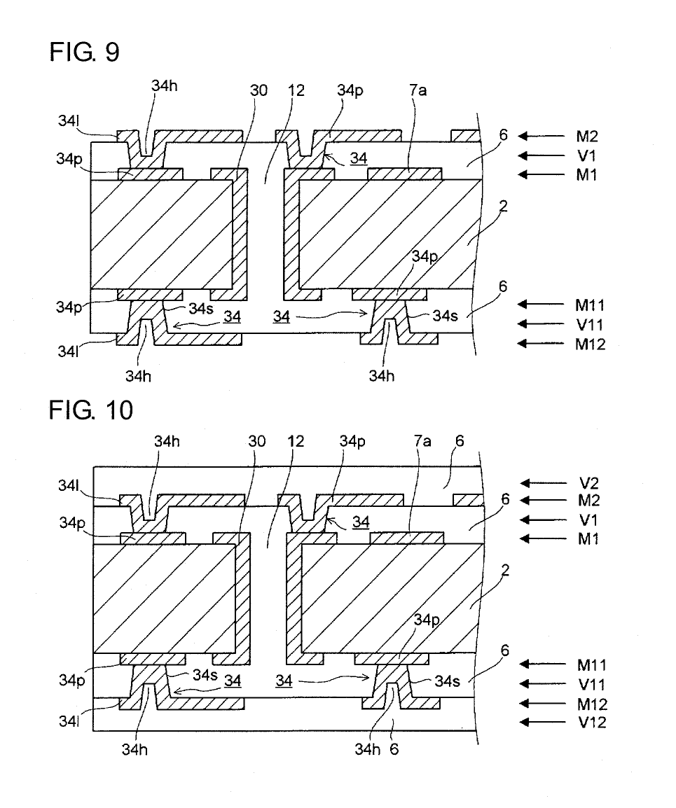

Then, as shown in FIG. 9, the first conductor layers M2, M12 and the via conductors 34s are formed by the pattern plating. The first conductor layer M2, and the like are formed by the semi-additive process, or the like as follows. At first, an electroless copper plating film, for example, is formed on the second via layers V2, V12, then a resist is formed on this electroless copper plating film, and then the first conductor layer M2, and the like are formed by applying the electrolytic copper plating to the resist non-formed areas. In this case, the first conductor layer M2, and the like can be formed as predetermined patterns by peeling/removing the resist using KOH, or the like.

Then, the roughening process is applied to the first conductor layers M2, M12. Then, as shown in FIG. 10, the second via layers V2, V12 are obtained by laminating/curing the resin film 6 to cover the first conductor layers M2, M12. As occasion demands, this resin film may contain the fillers, as described above.

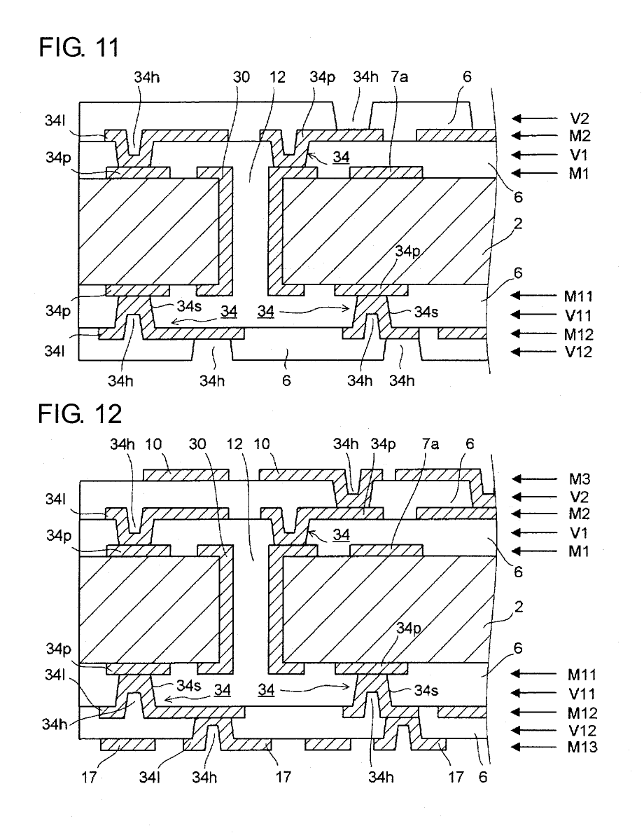

Then, as shown in FIG. 11, the via holes 34h are formed in a predetermined pattern by irradiating the laser beam onto the principal surfaces of the insulating layers V2, V12 (via layers). Then, the roughening process is applied to the insulating layers V2, V12 containing the via holes 34h. When the roughening process is applied to the insulating layers V2, V12, as described above, in such a situation that the insulating layers V2, V12 contain the fillers, the liberation of the fillers is caused and the fillers still remain on the insulating layers V1, V11. Therefore, the water rinsing or the air blowing is applied appropriately like the above. Then, the desmear process and the profile etching (the outline etching) are applied to the via holes 34h to clean the inside of the via holes 34h.

Then, as shown in FIG. 12, the second conductor layers M3, M13 and the via conductors 34s are formed by the pattern plating.

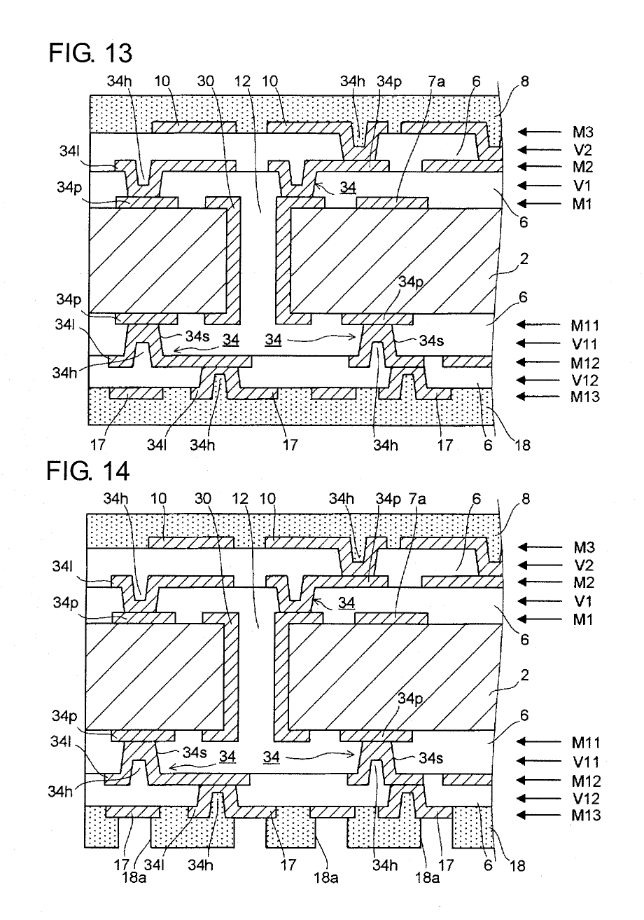

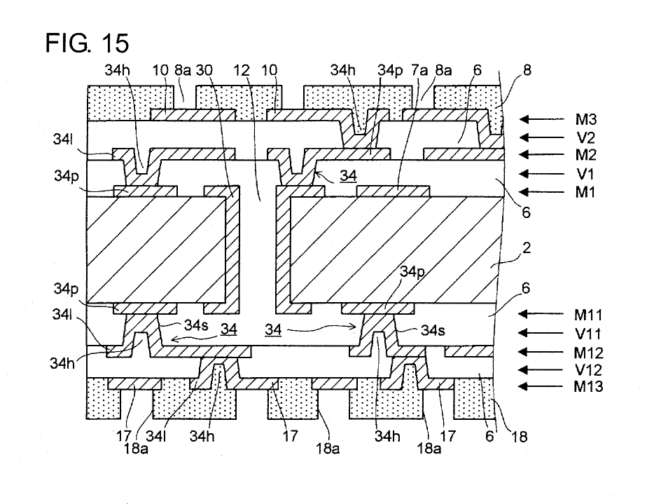

Then, as shown in FIG. 13, the solder resist layers 8 and 18 are formed on the second conductor layers M3, M13 respectively to bury the inside of the via holes 34h. Then, as shown in FIG. 14 and FIG. 15, the opening portions 8a and 18a are formed by applying the resist coating and the exposing/developing processes to the solder resist layers 8 and 18. Here, FIG. 15 is a process view showing the process applied to the corresponding section in FIG. 3 when the wiring substrate is cut along line I-I of the wiring substrate.

Then, in the assembly shown in FIG. 14, the Sn-containing underlying layer 17a is formed on the metal terminal pads 17 (i.e., the underlying layer forming step), each of which is exposed from the opening portion 18a, by the plating method such as the electroless plating, the electrolytic plating, or the like, for example, respectively, then the solder balls 19 are mounted on the Sn-containing underlying layers 17a respectively (i.e., the solder supplying step), and then the solder balls 19 and the metal terminal pads 17 are connected together by applying the reflow soldering process (i.e., the solder connecting step). In this case, the solder balls 19 contain no flux for the oxide film removal. Therefore, as the pretreatment needed to form the solder balls 19, the flux for the oxide film removal is coated on the Sn-containing underlying layers 17a, and then the solder balls 19 are formed. Here, the flux for the oxide film removal is brought into an active state by the reflow soldering process, and thus the oxide film formed on the surfaces of the Sn-containing underlying layers 17a respectively can be removed.

Meanwhile, in the assembly shown in FIG. 15, the Sn-containing underlying layer 10a is formed on the metal terminal pads 10 (i.e., the underlying layer forming step), each of which is exposed from the opening portion 8a, by the plating method such as the electroless plating, the electrolytic plating, or the like, for example, respectively. Then, the solder bump 11 is formed on the Sn-containing underlying layers 10a respectively (i.e., the solder supplying step). Then, these solder bumps 11 are connected electrically to the corresponding metal terminal pads 10 simultaneously with the connection of the solder balls 19 to the metal terminal pads 17 by applying the reflow soldering process (i.e., the solder connecting step).

Here, when the solder paste used in forming the solder bumps 11 contain no flux for the oxide film removal, the underlying layers 10a are processed by using the flux for the oxide film removal as the pretreatment, which is needed to form the solder balls 19, to remove the oxide film formed on the surfaces of the underlying layers 10a, and then the solder bumps 11 are formed. In this case, when the solder paste contain the flux for the oxide film removal, the oxide film formed on the surfaces of the underlying layers 10a can be removed by printing the solder paste and then applying the reflow soldering process even though the above the pretreatment isn't applied.

The wiring substrate 1 as shown in FIGS. 1 to 4 is obtained through the above-mentioned steps.

The plasma process can be applied to the solder resist layers 8, 18, if necessary. This plasma process is executed to activate the solder resist layers 8, 18, particularly the surfaces of them, by the plasma irradiation. According to this process, for example, the wettability of the solder with respect to the sealing resin layer can be improved in the packaging process, and thus the coating property of the sealing resin layer can be improved. In particular, when an underfill resin should be filled into narrow clearances between the wiring substrate and the semiconductor device, etc., for example, such underfill resin spreads readily over the wiring substrate, i.e., the solder resist layers 8, due to the above improvement of the wettability. As a result, the injection of the underfill resin, which is difficult in the prior art, can be easily executed.

With the above, the present invention is explained in detail while citing the concrete examples. The present invention is not restricted to the above contents, and all variations and modifications can be applied without departing from a scope of the present invention.

For example, in the above concrete examples, the explanation of the wiring substrate 1 having the core substrate 2 is made. But of course the manufacturing method of the present invention can be applied to the wiring substratel that does not have the core substrate 2.

What is claimed is:

1. A method of manufacturing a wiring substrate having a first principal surface side and a second principal surface side opposing to the first principal surface side, the wiring substrate including conductor layers and resin insulating layers alternately stacked, and solder resist layers having opening portions and formed on an outermost surface of each of the first principal surface side and the second principal surface side, respectively, such that outermost conductor layers of the conductor layers are exposed from the opening portions of the respective solder resist layers, the method comprising:
an underlying layer forming step of forming Sn-containing underlying layers on the respective outermost conductor layers exposed from the opening portions, the Sn-containing underlying layers including a first underlying layer positioned on the first principal surface side and a second underlying layer positioned on the second principal surface side;
a solder supplying step of supplying a first solder onto the first underlying layer and a second solder onto the second underlying layer; and
a solder connecting step of connecting the first solder to the first underlying layer and the second solder to the second underlying layer by heating the first solder and the second solder simultaneously.

2. The method according to claim 1, wherein at least one of the first solder and the second solder is a solder paste that contains a flux for oxide film removal.

3. The method according to claim 1, wherein at least one of the first solder and the second solder is a solder paste, and further comprising:
a flux supplying step of supplying a flux for oxide film removal to the respective Sn-containing underlying layer to which the solder paste is supplied, after the underlying layer forming step but before the solder supplying step.

4. The method according to claim 1, wherein at least one of the first solder and the second solder is a solder ball, and further comprising:
a flux supplying step of supplying a flux for oxide film removal to the respective Sn-containing underlying layer to which the solder ball is supplied, after the underlying layer forming step but before the solder supplying step.
